(19) United States
(12) Patent Application Publication
(10) Pub. No.: US 2006/0191899 A1
(43) Pub. Date: Aug. 31, 2006

(54) METHOD FOR PRODUCING AN OVERTEMPERATURE PROTECTION DEVICE AND CORRESPONDING OVERTEMPERATURE PROTECTION DEVICE

(75) Inventor: Michael Tafferner, 76316 Malsch (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH, Oberderdingen (DE)

(21) Appl. No.: 11/383,615

(22) Filed: May 16, 2006

Related U.S. Application Data
(63) Continuation of application No. PCT/EP04/12703, filed on Nov. 10, 2004.

(30) Foreign Application Priority Data
Nov. 18, 2003 (DE) 103 55 282.0

(51) Int. Cl. H05B 1/02

(52) U.S. Cl. 219/505

(57) ABSTRACT

An over temperature protection device can be applied to a support surface having a heat conductor. The heat conductor has an interruption forming a gap, on the top of which a tin-based protection element is prefixed by an adhesive. In one embodiment, the ends of the protection element project beyond the heat conductor and are electrically contacted to the heat conductor by a silver/polymer paste.

### CROSS-REFERENCE TO RELATED APPLICATIONS

This application is a continuation of PCT/EP 2004/012703 filed on Nov. 10, 2004, which in turn claims priority to German Appl. No. 103 55 282.0 filed on Nov. 18, 2003.

### FIELD OF INVENTION

The present invention generally relates to a device for protecting from over-temperature, such as in a household appliance, as well as method of the manufacture of such a device.

### BACKGROUND OF THE INVENTION

Various household appliances incorporate heating elements, and the appliances typically incorporate safety mechanisms for detection of excess temperatures. DE 101 50 027 C1 discloses one such device comprising a thick film protection component with a melting conducting element and heating resistor element. A resistance layer as a melting conducting element is placed directly over a gap between two ends of a conductor layer of the heating resistor element. If the temperature is excessive, the melting conducting element melts and interrupts the electric supply.

In another embodiment, DE 197 04 097 also discloses the construction of an excess temperature protection device with a melting conducting element on a glass ceramic support.

It is desirable to provide a method and an excess temperature protection device as defined hereinbefore making it possible to obviate the prior art problems and in particular enabling an excessive temperature protection device to be manufactured in a simple, easily adaptable manner and which can be integrated into small layouts, is operationally reliable and universally usable.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a cross-section view of a first embodiment of an excess temperature protection device with a conductive polymer paste between the heating conductors and the protection element.

FIG. 2 is a cross-section view of another embodiment in which the protection element and the contact blanks are welded for achieving electrical contact with respect to the heating conductor.

FIG. 3 is a composite plan jointly representing the two embodiments of FIGS. 1 and 2.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### Overview

One embodiment of the present invention is a method and an excess temperature protection device as defined hereinbefore making it possible for enabling an excessive temperature protection device to be manufactured in a simple, easily adaptable manner and which can be integrated into small layouts, is operationally reliable and universally usable.

One embodiment of the present invention provides a method having the features of claim 1 and an excess temperature protection device having the features of claim 12. Advantageous and preferred developments of the invention form the subject matter of further claims and are explained hereinafter. The features of the development of the excess temperature protection device according to the manufacturing method also apply to said device. By express reference the wording of the claims is made into part of the content of the description. Features relating both to the excess temperature protection device and the manufacturing method are in part only described once hereinafter, but apply both to the excess temperature protection device and the manufacturing method.

According to one embodiment of the invention, a heating conductor or heater is placed on a support during the manufacturing thereof. In one embodiment, the support may be a ceramic support. In the heating or warming area of a heating conductor an excess temperature protection device is provided in the current path to the power supply of said heating conductor. In a first step for the manufacture of said excess temperature protection device, one area or end of a protection element is mechanically fixed at least in the vicinity of the heating conductor. The protection element is made of a material having a melting point at a specific temperature. The electrically insulating, mechanical fixing of the protection element can advantageously take place as pre-fixing the protection element by adhesion, for example, by using an adhesive. The protection element can reach, or at least extend close to, an electrical conductor on either side of the interruption of the current path. In a second step, electrical contacting is achieved between the areas or ends of the protection element, and the heating conductor or its supply. The pre-fixing of the protection element facilitates further manufacturing steps. Particularly, the electrical contacting, can be more easily performed. Thus, for example, electrical contacting can take place in a continuous process, in which also other electrical contacts can be performed. This is explained in greater detail hereinafter.

The adhesive for the mechanical fixing or pre-fixing should remain stable and durable at the operating temperature of the heating conductor or heater, so that its fixing action is maintained. It can be self-hardening or hardenable by means of a hardener. The application of an adhesive can take place in conventional manner for manufacturing methods, for example in a continuous process using screen printing, a dispenser, etc. The adhesive can be applied directly to the support. This advantageously takes place between two open ends of an electric circuit or in the current path for supplying the heating conductor or in the heating conductor path. This space can be constructed in the manner of a gap. Following the application of the adhesive, the protection element can be mounted.

One embodiment for producing the electrical contact between the protection element and the heating conductor involves application of an electrically conducting, contacting material. The material can be placed or deposited on and/or over the complete protection element. Alternatively, the material can place on each end near the heating conductor or other conductors for forming the current path between the heating conductor and the protection element. For this purpose it is possible to use polymer pastes comprising very good conducting metals therein, for example silver. The drying or hardening temperature of such a polymer paste should be below the protection element melting point. This ensures that during the normal operation that polymer paste will not cause any problems with the mechanical stability of the protection element relative to the heating conductor.

In another embodiment, it is possible to produce a direct, conductive connection of the protection element with the heating conductor (or other conductors) so as to form a current path by using welding. When welding the protection element to the heating conductor, the adhesive residues between the protection element and the heating conductor are melted away allowing a reliable electrical contact to be achieved between the two elements.

The protection element is advantageously elongated, for example as a rod or rectangle having a flat, or semi-flat cross-section. The flat cross-section has the advantage that there can be a very good heat conductance from the heat conductor to the protection element, which allows for rapid response of the protection device. The protection element can be made from a low melting alloy on the one hand or pure metal on the other. Through the choice of the constituents and a precise alloying ratio, a sired melting point and the melting behaviour can be achieved.

It is also possible to produce the protection element from a powder, which by means of an admixed, organic support forms a polymer paste. The paste can for example be applied by screen printing or a dispenser. In this case the characteristics of the adhesive for pre-fixing can be established through the polymer paste. Such a paste can be hardened after application. Through the hardening of the paste, an electrical contact is established at the conductor achieving a current path in general. Alternatively, the protection element can be affixed a separate process following the hardening operation, for example in one of the aforementioned ways.

After electrical contacting has taken place, a cover comprising a covering material layer can be applied to the above-described structure. The cover can also have an insulating function. It is advantageous to use an elastic, resistance covering material, particularly silicone. As a result, the protective device or excess temperature protection device is protected against external influences, which could negatively affect operation both before, during and after the melting of the protection element during at the desired temperature.

It is important that if the protection device does melt after detecting a high temperature condition, that the space between the heating conductor (or other conductor) and the remains of the protection element is made sufficiently large. Preferably, the space is at least 0.8 mm long, and advantageously 1 mm or more. Contact banks can be provided in the vicinity of the conductor or heating conductor on either side of the interruption and towards which mainly takes place contacting by means of the protection element. Silver contacts can be used here.

These and further features of various embodiments of the invention can be gathered from the claims, description and drawings and the individual features, both singly or in subcombinations. Embodiments of the present invention can be implemented in other applications and can represent advantageous, independently protectable constructions within the scope of the claimed invention. The subdivision of the application into individual sections and the subheadings in no way restricts the general validity of the statements made thereunder.

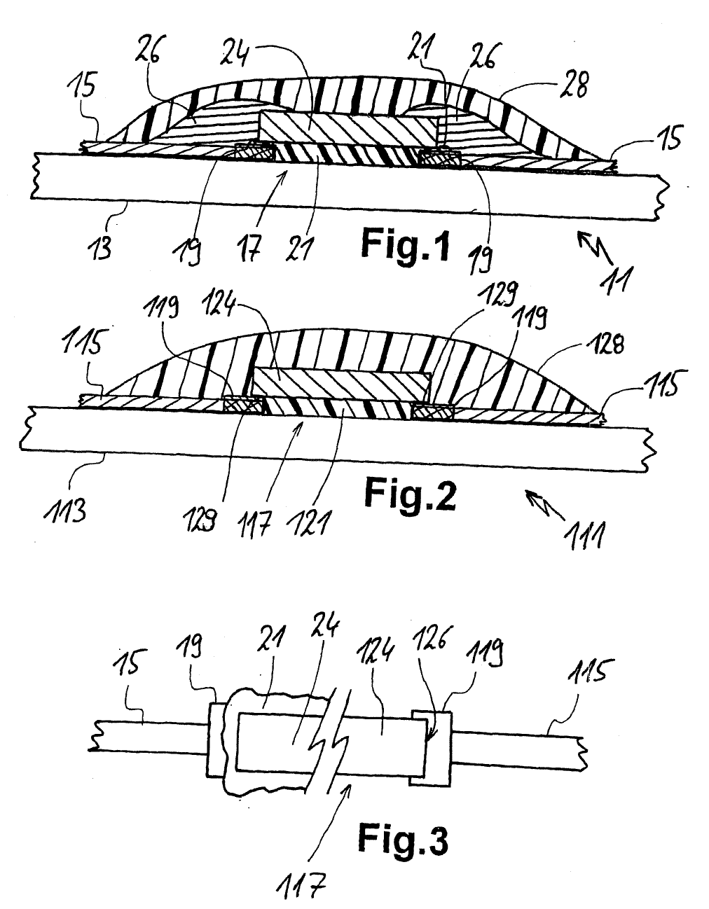

FIG. 1 shows an excess temperature protection device 11, such as can be integrated into a heating device, such as in a household appliance. A heating conductor 15 is placed on a support 13, which can be a thin ceramic plate. The heating conductor 15 can be a thick film heating element, for example according to DE 10021512 A1. There is an interruption 17 of the heating conduction having a width of a few millimeters in the path of the heating conductor. This interruption breaks the current path of the heating conductor. The ends of the heating conductor 15 extending up to said interruption 17 carry, or are affixed to, silver contact banks 19.

As shown in FIG. 1, adhesive 21 is placed in the area of the interruption 17 and on support 13. An elongated protection element 24 is pressed and affixed onto the adhesive 21. The protection element 24 projects over the length of the interruption 17 in such a way that it overlaps onto the silver contact banks 19. However, it is shown in FIG. 1 that the protection element 24 does not directly contact the silver contact banks 19 because there is a thin film of adhesive 21 between the protection element and the contact.

A silver polymer paste 26 is deposited at both ends of the protection element 24 or in the vicinity of the ends of heating conductor 15 for achieving electrical contact. The past may be in the form of a solder, and overlaps both the ends of the protection element 24 and also part of the silver contact banks 19 and, in particular, the end regions of heating conductor 15. Over this arrangement can be placed a silicone cover 28, which covers the complete structure shown, so that only the heating conductors 15 pass out from under cover 28.

The protection element 24 shown can be made of tin having a melting point of 232° C. Alloys of copper, or the use of for example zinc, is possible in the case of higher tripping or initiating temperatures. The dimensions of the protection element can be, for example, 3 mm in length, 2 mm in width, and a height of 0.1 mm. This makes it possible to protect against excess temperatures of a heating device with a rated power of over 2000 Watts.

FIG. 2 illustrates another embodiment of one aspect of the present invention. The excess temperature protection device 111 shown in FIG. 2 shows a protection element 124 affixed by an adhesive 121 in the vicinity of an interruption 117 between the ends of heating conductor 115. However, here electrical contacting takes place in that following affixing and possible hardening of the adhesive, the left and right-hand ends of the protection element 124 are welded to the silver contact banks 119. Welding 129 can be in the form of contact welding or tacking. The adhesive 121, which in certain circumstances is located between the silver contact bank 119 and protection element 124, is burned or evaporated by the high welding temperature, so that in all cases a through electrical connection is obtained.

Thus, while a double welding process is required, it is possible to economize the application of the contacting polymer paste compared to the embodiment shown FIG. 1. Finally the protection device is once again covered by a cover 128.

FIG. 3 shows a composite plan view in which the left side of FIG. 3 corresponds to the embodiment of FIG. 1 and the right side of FIG. 3 correspond to the embodiment of FIG. 2. It is apparent from the left hand side of the plan view of FIG. 3 that the adhesive 21 contacting the excess temperature protection device 11 passes out or flows sideways. Thus, the adhesive 21 is also located between the contact bank 19 and protection element 24. However, in the case of the right side, the adhesive 121 does not flow and is cannot be seen as it is blocked from view by the excess temperature protection device 111 shown.

### Manufacturing Method

The manufacturing method for the above-described excess temperature protection device is now discussed, using for reference the numbers for element shown in FIG. 1. It is presumed that the support 13 with the heating conductors 15 are already present. The silver contact banks 19 can be applied as a coating on either side of interruption 17. Alternatively, the heating conductors 15 can also be provided with a good conducting coating, for example silver, already applied in the appropriate area.

Next a small amount of adhesive 21 is placed in interruption 17. This can be effected by various application devices, for example, by spray dosing or screen printing. The protection element 24 is then placed on the adhesive in such a way that its ends preferably rest on, or at least overlap, the silver contact banks 19 or heating conductors 15. The adhesive 21 is, in certain circumstances, hardened or self-hardening. When the adhesive 21 is hardened, the pre-fixing of protection element 24 has taken place.

The next step involves completing the electrical contacting between the protection element 24 and heating conductors 15. For this purpose the above-described silver polymer paste 26 can be applied, for example, in the same way as adhesive 21. Following the hardening of the silver polymer paste 26, there must be no deterioration of the properties or structure of the protection element 24. If the excess temperature protection device is to be used for protecting against very high temperatures, the silver polymer paste 26 can be replaced by a silver conducting paste.

In the case of the embodiment according to FIG. 2, following the hardening of the adhesive 121, the end of the protection element 124 is welded to the silver contact bank 119 beneath it.

Finally a cover is placed on protection device 11 or 111, for example in the form of the above-described silicone layer. It is also possible to use plastic or other types of material as the cover.

When using a silver polymer or other silver paste according to FIG. 1 for producing electrical contacting, the latter is less sensitive to a temperature rise. This leads to a slower response of the protection device. However, the welded joint shown in FIG. 2 makes the contacting relatively susceptible to temperature fluctuations, particularly a temperature rise. If a particularly rapid response is desired, the use of a welded joint is recommended.

Using one of the excess temperature protection devices as shown in the aforementioned drawings, it is possible on integration of the protection element with the heating conductor to directly monitor the latter and consequently the heating circuit. It is also possible to provide such an excess temperature protection device in the vicinity of a circuit supplying current to a heating conductor, i.e. exclusively in the electric leads. Thus, the occurrence of excess temperatures can be reliably avoided at given, selectable points.

One possible use of the above invention is, for example, a heating device for a water boiler or hotplate. If all the water has evaporated after boiling, the temperature of the hotplate would exceed a maximum permitted value. When using a protection device according to the invention here, it is possible to prevent the device to exceed a settable temperature, for example approximately 230° C.

That which is claimed:

1. A method for the manufacture of an excess temperature protection device comprising the steps of:
providing a support surface having a heating conductor placed thereon, wherein the heating conductor has a first end with a first contact lead and a second end with a second contact lead, and a gap formed between said first contact lead and said second contact lead;
affixing in the vicinity of said heating conductor a protection element formed of a material having a melting point at a specific temperature and having a first end and a second end, such that the first end of the protection element is place over the first contact lead and the second end of the protection element is place over the second contact lead; and
achieving an electrical connection between said first end and said second end of said protection element and said first contact lead and said second contact lead of said heating conductor, respectively.

2. The method according to claim 1, wherein said affixing takes place by means of an insulating adhesive, said adhesive being stable and durable at operating temperatures of said heating conductor.

3. The method according to claim 2, wherein said adhesive is applied directly to said support surface and onto which said protection element is subsequently placed.

4. The method according to claim 3, wherein said adhesive is applied in the gap formed between the first contact lead and the second contact lead of said heating conductor.

5. The method according to claim 1, wherein said electrical connection of said protection element with said first and second contact lead occurs by means of applying an electrically conducting, contacting material having a drying or hardening temperature below said melting point of said protection element.

6. The method according to claim 1, wherein said electrical connection of said protection element with said first and second contact leads of said heating conductor is achieved by a welding action.

7. The method according to claim 1, wherein said protection element is elongated and rod-shaped.

8. The method according to claim 1, wherein said protection element comprises a single component comprising a low melting alloy or a pure metal.

9. The method according to claim 1, wherein said protection element is applied as a polymer paste in powder form with the aid of an admixed, organic support, wherein application thereof takes place using a dispenser or by screen printing

10. The method according to claim 9, wherein said polymer paste is hardened after application.

11. The method according to claim 1, wherein a coating of a covering material is applied to said structure of said excess temperature protection device.

12. An excess temperature protection device comprising:
a support surface having a heating conductor thereon, wherein the heating conductor comprises a first contact area and a second contact area thereby forming a gap interrupting a current path of the heating conductor; and
a protection element formed of a metal with a melting point at a specific temperature having a first end and a second end, the protection element affixed in the vicinity of said gap in such a way that the first end and second end overlap the first contact area and the second contact area of the heating conductor respectively, thereby establishing an electrical connection from the first contact area through the protection element and to the second contact area.

13. The excess temperature protection device according to claim 12, wherein said protection element is affixed using an adhesive on said first contact area and second contact area, or on said support surface.

14. The excess temperature protection device according to claim 12, wherein said electrical connection of said protection element with said first contact area and said second contact area is achieved by using an electrically conductive, contacting material on said heating conductor.

15. The excess temperature protection device according to claim 14, wherein said electrically conductive, contacting material is a silver polymer paste.

16. The excess temperature protection device according to claim 12, wherein said electrical connection at said first contact area and said second contact area is achieved by a first welded connection between said first contact area and said first end, and a second welded connection between said second contact area and said second end.

17. The excess temperature protection device according to claim 12, wherein said protection element is placed in a heating area of said heating conductor.

18. The excess temperature protection device according to claim 17, wherein upon melting the protection element forms a space interrupting the electrical connection between said first contact area and said second contact area.

19. The excess temperature protection device according to claim 18, wherein the space is at least 0.8 mm.

20. The excess temperature protection device according to claim 12, wherein said material of said protection element is a pure metal or a low melting alloy

21. The excess temperature protection device according to claim 20, wherein the melting point of said protection element is the tripping temperature of said excess temperature protection device.

22. The excess temperature protection device according to claim 12, wherein a cover is provided in a non-releasable manner at least over said protection element.

23. The excess temperature protection device according to claim 22, wherein said cover comprises silicone.

24. The excess temperature protection device according to claim 12, wherein the first and second contact area comprises a first and second contact bank comprising silver in electrical contact with said first end and second end respectively of the heating conductor.

25. The excess temperature protection device according to claim 12, wherein said protection element is an in an elongated, rod shape.

26. The excess temperature protection device according to claim 12 wherein said protection element is a rectangular ribbon of metal.
